(19) United States
(12) Patent Application Publication
(10) Pub. No.: US 2006/0172171 A1
(43) Pub. Date: Aug. 3, 2006

(54) Devices for the supplying fuel to fuel cells

(76) Inventors: Klaus Deinzer, Schlieren (CH); Rafael Rensch, Trun (CH); Christoph Rebsamen, Zurich (CH); Andreas Koll, Zurich (CH)

Correspondence Address: IP STRATEGIES, 12 1/2 WALL STREET, SUITE I, ASHEVILLE, NC, 28801, US

(21) Appl. No.: 10/495,297

(22) PCT Filed: Nov. 13, 2002
(86) PCT No.: PCT/EP02/12701

§ 371 Date: Nov. 16, 2004

(30) Foreign Application Priority Data
Nov. 13, 2001 (EP) 01126949.5

(51) Int. Cl. H01M 8/04; B65D 17/50; B65D 43/26; B65D 6/00

(52) U.S. Cl. 429/34; 220/260; 220/284; 220/4.12

(57) ABSTRACT

This invention relates to a fuel cartridge for the supply of a fuel cell device, with an outlet device, which is formed such that it can be opened by an opening device of a cartridge receptacle device appropriate to the fuel cartridge. Furthermore, the invention relates to a cartridge receptacle device for a fuel cartridge of this type which comprises guidance and retention devices for guiding and retaining the fuel cartridge, opening devices for opening the fuel cartridge, and fuel extraction devices for extracting the fuel from the fuel cartridge. In addition the invention relates to a fuel cell device with this type of cartridge receptacle device.

This invention relates to devices for the supply of fuel cell systems with fuel. In particular, the invention relates to fuel cartridges for fuel cell systems and devices to ensure a safe and controllable feed of fuel from the fuel cartridges into the fuel cell systems.

### STATE OF THE ART

Even in those fields of application in which the fuel cell has clear advantages over non-rechargeable or rechargeable batteries, often the classical methods of supplying power independent of a network are preferred instead of fuel cells. The reasons for this are often not that the relevant technology is more advantageous or more developed, but rather that used non-rechargeable batteries can be easily replaced by unused ones, discharged rechargeable batteries can be easily recharged and furthermore in many applications rechargeable and/or non-rechargeable batteries can be used alternatively.

The (continuous) supply of power with a fuel cell requires a (continuous) supply of the fuel cell with fuel. In this respect it is usual to realise this fuel feed taking into account individual points of view, which is on one hand comparatively expensive and ineffective and on the other hand results in that different approaches to a solution are often incompatible to one another for different applications. In the field of so-called consumer electronics fuel cell devices used normally include an integrated fuel tank with a supply of fuel which is sufficient for operation of up to a number of hours. When this supply has been consumed, then the fuel tank must be filled again, which is relatively complicated: Usually here, the operation of the fuel cell must be interrupted and strict safety requirements must be followed.

Therefore, it is the object of this invention to remedy these disadvantages arising with supplying power with fuel cells and in particular to improve the supply of fuel to fuel cells.

### DESCRIPTION OF THE INVENTION

To solve this object a fuel cartridge is provided and a cartridge receptacle device for the fuel cartridge. Also, the invention provides for devices for the dosage of the fuel flow from a fuel cartridge inserted into the cartridge receptacle device.

According to a first aspect of this invention, a fuel cartridge is provided for the supply of a fuel cell device which exhibits an outlet device which is formed such that it can be opened by an opening device of a cartridge receptacle device appropriate to the fuel cartridge.

According to a second aspect of this invention a cartridge receptacle device for this type of fuel cartridge is provided which exhibits guidance and retention devices for guiding/retaining the fuel cartridge, opening devices for opening the fuel cartridge and fuel extraction devices for extracting the fuel from the fuel cartridge.

The fuel cartridge according to the invention can be used both for refilling a fuel tank of a fuel cell device or also directly as tank cartridge for operating a fuel cell device. The replacement of an empty fuel cartridge by a full fuel cartridge takes just a short time and can be carried out very similarly to a change of battery. The outlet device of the fuel cartridge is formed such that, when used properly, it can only be opened in the corresponding cartridge receptacle device. The interface outlet device/opening device between the cartridge and the cartridge receptacle device is formed with a seal secure against fluids so that hazards due to fuel being emitted unintentionally can largely be eliminated.

In a preferred development the fuel cartridge and/or the cartridge receptacle device comprises a device for conveying the fuel to a fuel chamber in the fuel cartridge using pressure.

In this case the fuel flows through the opened outlet opening without active pumping of the fuel by a pump fitted in the fuel line to the fuel cell being necessary. Consequently, smaller dimensioning of the total system is possible.

In advantageous developments of the fuel cartridge and/or the cartridge receptacle device the devices for applying the pressure comprise a gas.

In this way the fuel in the fuel cartridge can be subjected to pressure by a pressurised gas provided within the cartridge. In this case a fuel cartridge filled ready for fitting stands under pressure. Alternatively, unpressurised fuel cartridges can be provided in which the fuel is subjected to pressure only after fitting into the cartridge receptacle device. In certain fields of application these unpressurised fuel cartridges may be preferred over pressurised cartridges for safety reasons. The application of pressure to the fuel can be implemented in both cases by gas generation cells. Gas pressure cartridges based on CO₂ can also be used.

In an especially preferred development the device for applying the pressure exhibits a compression spring.

Compression springs represent a simple, economic means of applying a pressure which is less susceptible to external influences (in particular to temperature and pressure changes). They act on at least one movable or extendable wall of a fuel reservoir or on a piston extending into the fuel chamber. They can be provided within the cartridge and may also be a constituent part of the cartridge receptacle device.

In particular with regard to the application of unpressurised fuel cartridges, the devices for applying the pressure preferably comprise devices which enable the fuel to be subjected to pressure in the fuel cartridge by the application of an external force.

The extraction of the fuel occurs through the outlet device of the fuel cartridge. The outlet device may, for example, be a hole or other recess in the cartridge housing. In the simplest case the outlet device is formed by a specified section of the cartridge housing which is penetrated on opening the cartridge. To simplify the opening procedure, this section may be appropriately preformed, for example by an indentation for guiding the opening device.

In most developments the outlet device is less suitable on its own for a renewed closure of the once opened cartridge, so that in advantageous developments it exhibits a closure device closing the outlet device of the cartridge, the said closure device enabling repeated opening and closure of the fuel cartridge. Preferably, this closure device comprises a non-return valve.

This type of closure device simplifies the safe handling of already opened fuel cartridges and enables the partially emptied cartridges to be removed without hazard from the cartridge receptacle device, for example, to replace them by full cartridges.

Particularly advantageous with regard to the latter aspect—but also of advantage in other developments—a filling indicator indicating the fuel level in the cartridges can be provided for the fuel cartridges according to the invention.

This enables a simple check of the consumption and therefore quick recognition of operating conditions to be made, in particular of deviations from the ideal operating conditions, and prompt provision of replenishment.

In an especially preferred development of the invention the fuel cartridge and/or the cartridge receptacle device comprise/comprises a dosing device to control the flow of fuel from the cartridge.

Consequently, the flow of fuel can be easily matched to changed requirements, for example, due to variable operating conditions. In particular, a number of dosing devices can be used which are designed for coarse and fine dosing.

In an advantageous development the dosing device comprises a pump device, because the dosage can then be controlled directly and actively via the delivery rate of the pump device.

In particular for compact and miniaturised applications of fuel cells, micropumps are preferred embodiments of pump devices: they can be easily controlled, they are precise, economically priced and have an extremely small space requirement, so that they can be fitted almost anywhere.

In an advantageous development the dosing device comprises at least one valve which can be actuated.

In particular with those combinations of cartridge and cartridge receptacle device with which the fuel is conveyed by an overpressure, this sort of valve represents a simple and precise way of controlling the fuel flow.

Preferably the at least one valve is actuated magnetically or piezoelectrically, because this enables fast activation, but it is highly precise and less complicated mechanically.

Depending on the magnitude of the desired flow quantities, the fuel properties such as viscosity and other fluid-mechanical or control-specific view points, the at least one valve may be a needle valve and/or a disc valve and/or a slide valve.

The described cartridges are very well suited to safe transport and safe storage of the fuel as well as for safe extraction of the fuel by appropriately formed cartridge receptacle devices. Hence, the fuel cartridges according to the invention can be directly used advantageously as refill cartridges and/or as tank cartridges in fuel cell devices when they are equipped with such a cartridge receptacle device.

In the first case they enable the fuel tank of a fuel cell device to be filled simply and safely. In the second and especially preferred case, that is when used as a tank cartridge, there is the possibility of designing compact embodiments of fuel cell devices in which the fuel cartridge supplies the fuel cell device with fuel continuously during operation.

With regard to the hazard potential of fuels used for fuel cells, developments of the fuel cartridge according to the invention are preferred which either completely eliminate the multiple use of a fuel cartridge or make it more difficult and which render its use dependent on a safety check by qualified personnel. In this respect the cartridge exhibits a safety device which is damaged during the insertion process into the cartridge receptacle device and/or during removal from the cartridge receptacle device. Here, the damage can be reversible or irreversible; a repair or replacement of damaged parts should only be possible—if at all—by qualified specialist personnel or be associated with a disproportionately large effort for persons not specially authorised.

The safety device can be formed such that the damage renders the refilling of the cartridge completely impossible. Similarly as for camping gas cartridges, this can be achieved, for example, by the perforation of the cartridge in the outlet section during the insertion stage so that only the combination of the cartridge receptacle device including the inserted cartridge is sealed to the outside, but not just the cartridge alone.

Alternatively, the safety device can exhibit elements which are broken off or damaged during the insertion and/or removal of the cartridge, for example they are bent, such that they render renewed insertion of the cartridge in a cartridge receptacle device and/or refilling of the cartridge dependent on a replacement of the damaged elements by undamaged elements. For this purpose, these elements are designed so complex that for a lay person they can only be replicated or repaired with a disproportionately large effort. Further safety can be obtained in that the replacement process requires a device specially provided for the purpose.

In especially advantageous developments the cartridge receptacle device according to the invention exhibits retention devices (such as latching elements, compression springs, etc.) and/or guide devices (such as guide rails, centring elements, etc.) which all contribute and ensure that the interface between the outlet device of the cartridge and the opening device of the cartridge receptacle device is formed to seal reliably and in a repeatable manner.

According to a further aspect of this invention a fuel cell device with at least one cartridge receptacle device as described above is provided.

This type of fuel cell device can be operated directly with the cartridges according to the invention without the necessity of design changes. With two (or more) cartridge receptacle devices it is accordingly possible to employ two (or more) fuel cell cartridges in parallel, which preferably are emptied one after the other so that the operation of the fuel cell device is maintained during the replacement of one fuel cell cartridge.

For further explanation, preferred embodiments of this invention are described in the following with reference to the enclosed figures. The following are shown:

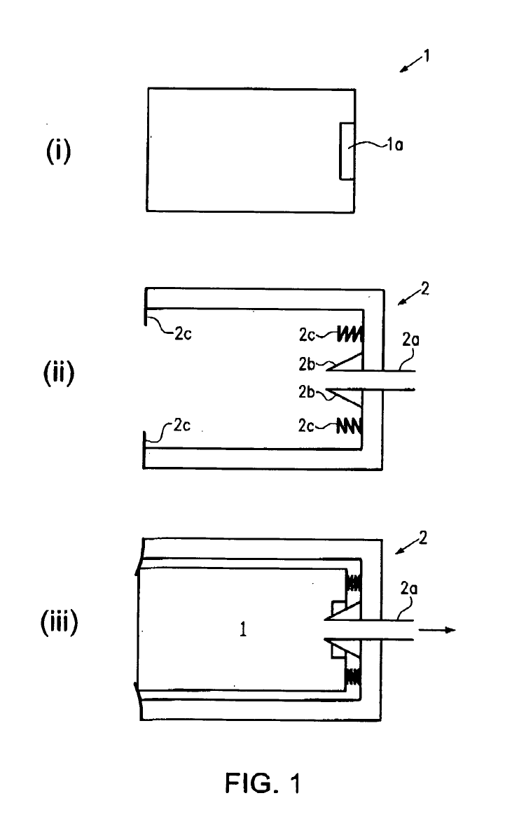

FIG. 1: in a schematic view, a fuel cartridge according to the invention, a cartridge receptacle device according to the invention and the combined usage of both of them;

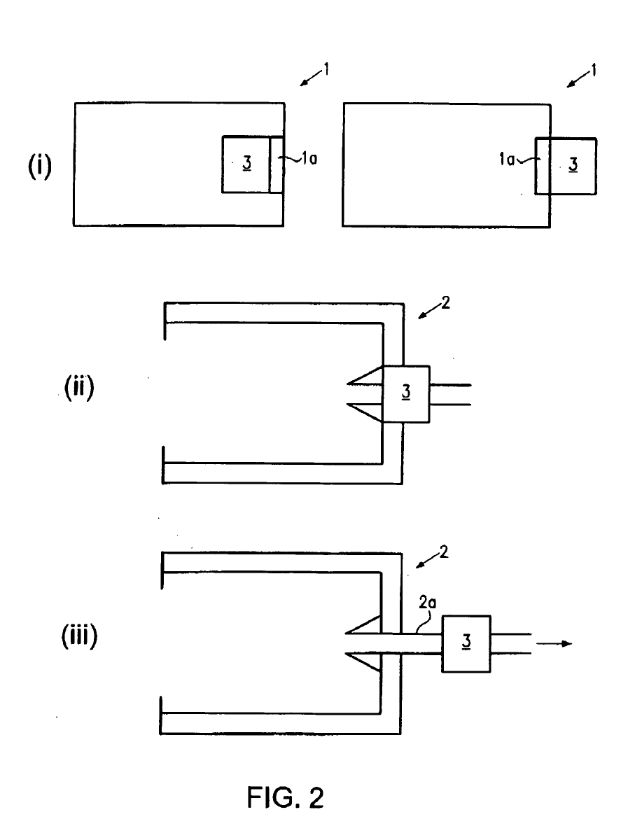

FIG. 2: the use of a dosing device with the devices according to the invention from FIG. 1;

FIG. 3: a first embodiment of a fuel cartridge according to the invention;

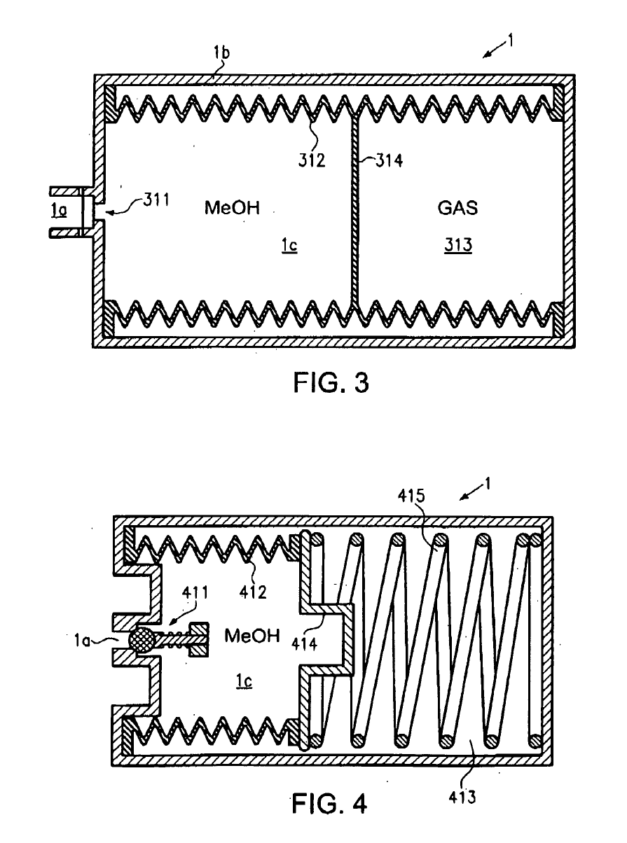

FIG. 4: a second embodiment of a fuel cartridge according to the invention;

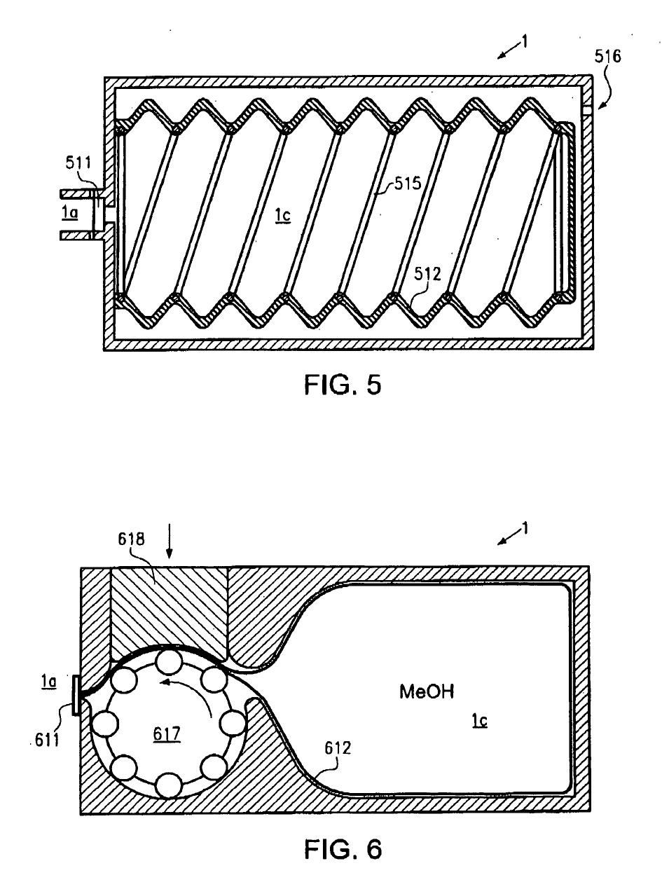

FIG. 5: a third embodiment of a fuel cartridge according to the invention;

FIG. 6: a fourth embodiment of a fuel cartridge according to the invention;

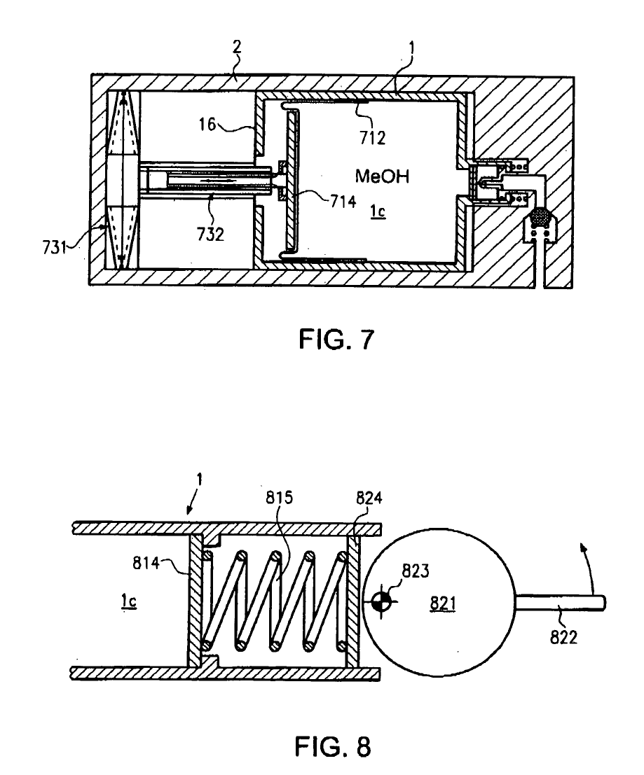

FIG. 7: a fifth embodiment of a fuel cartridge according to the invention;

FIG. 8: a sixth embodiment of a fuel cartridge according to the invention;

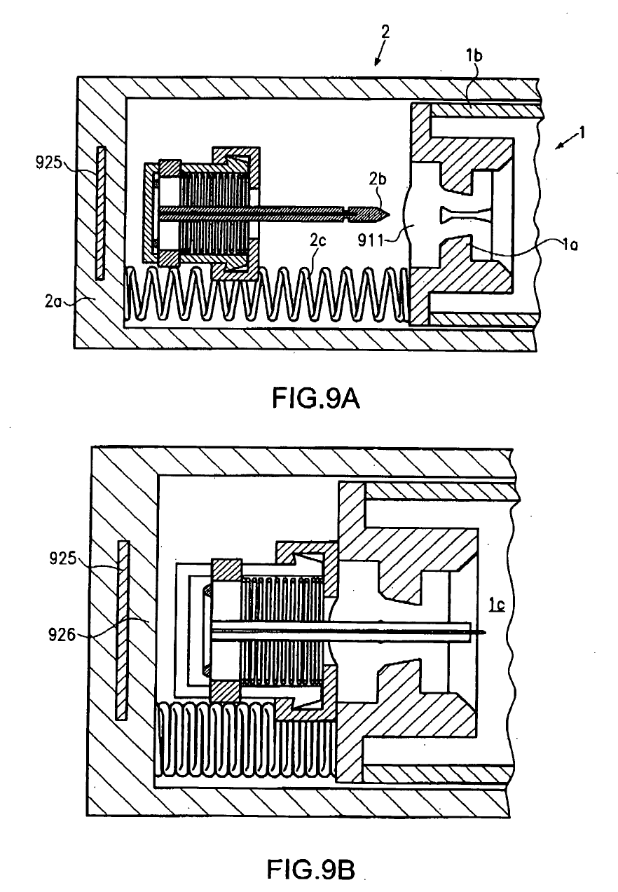

FIG. 9: a first embodiment of the formation of an interface between a cartridge according to the invention and a cartridge receptacle device according to the invention;

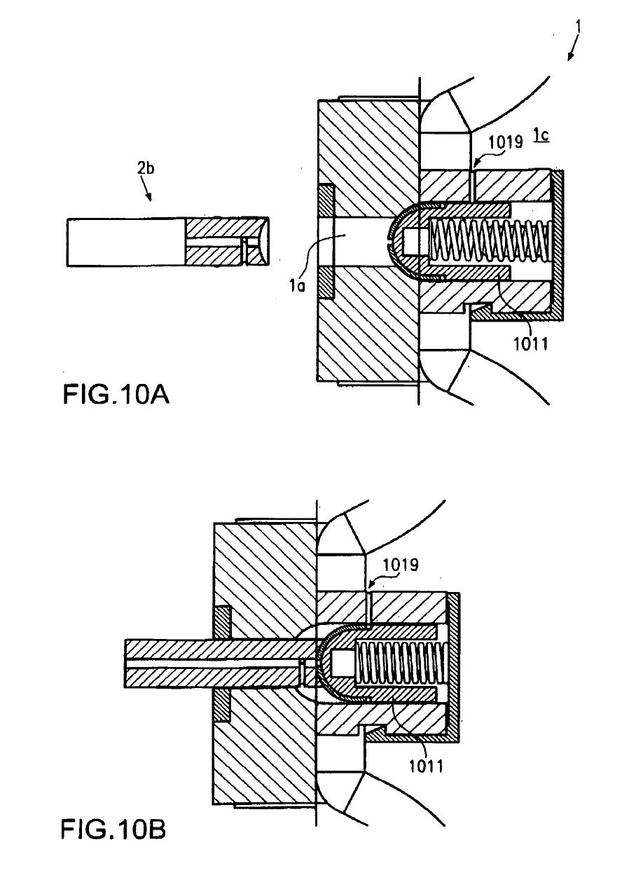

FIG. 10: a second embodiment of the formation of this type of interface;

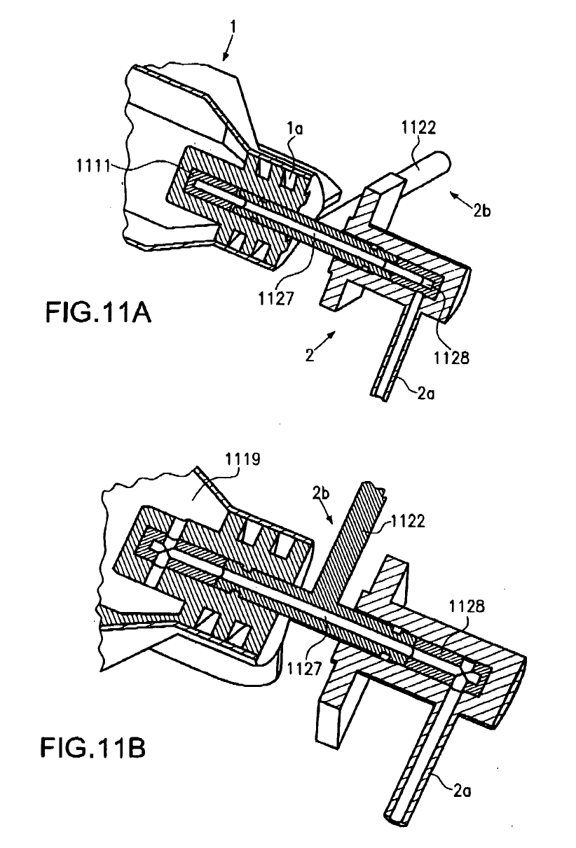

FIG. 11: a third embodiment of the formation of this type of interface;

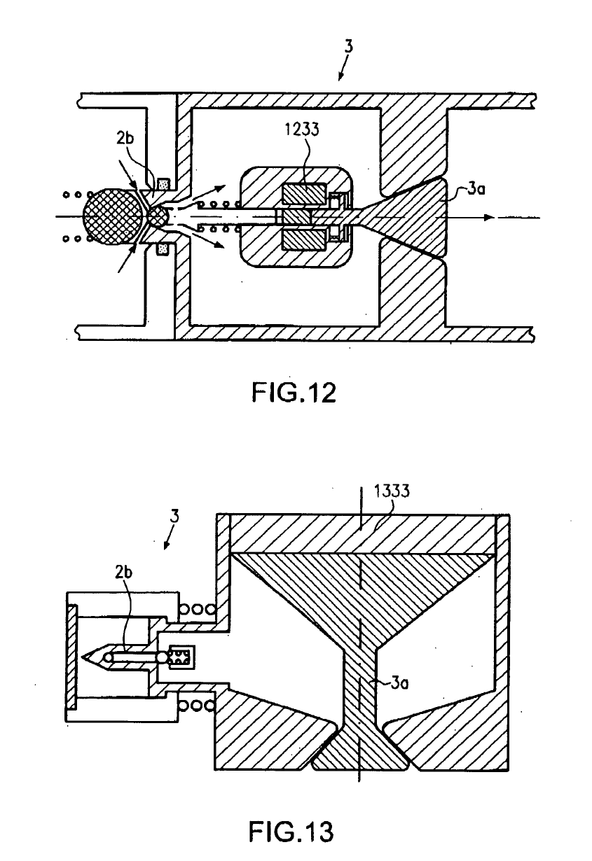

FIG. 12: a first preferred embodiment of a dosing device;

FIG. 13: a second preferred embodiment of a dosing device;

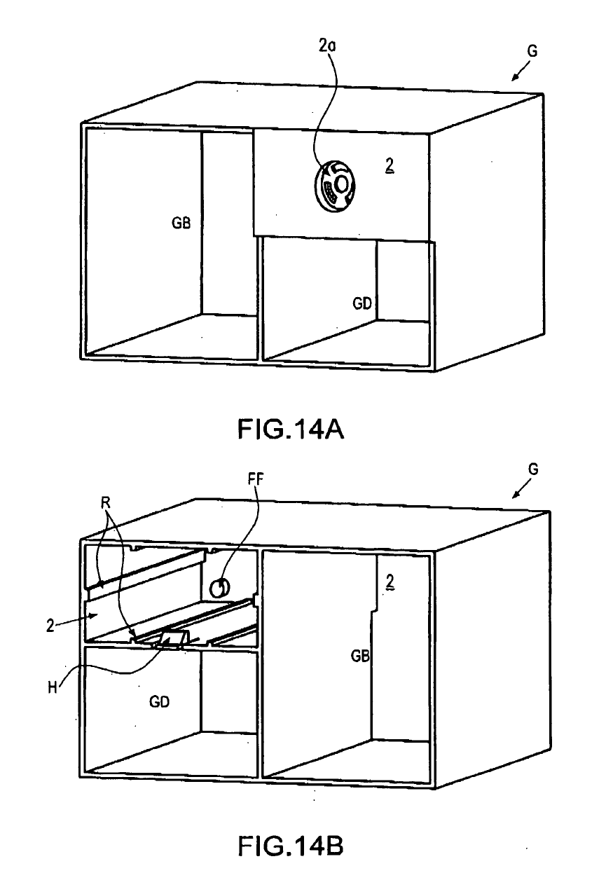

FIG. 14: a housing with compartments for devices for operating a fuel cell system, including a cartridge compartment;

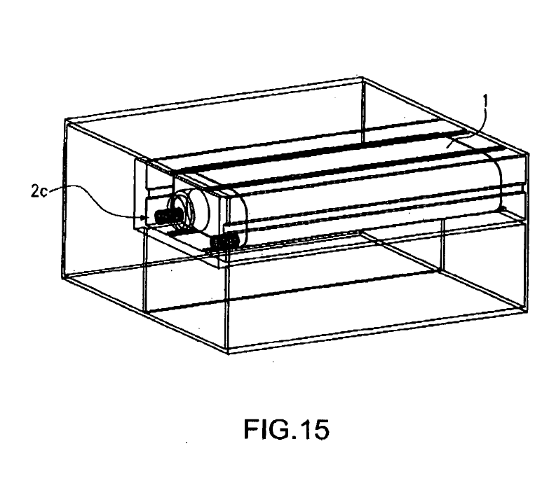

FIG. 15: a fuel cartridge inserted into the housing of FIG. 14.

The substantially schematised FIGS. 1 and 2 provide an illustration of some basic principles of this invention.

FIG. 1(i) shows a fuel cartridge 1 with an outlet section 1a through which the extraction of fuel from the cartridge 1 occurs.

FIG. 1(ii) shows a cartridge receptacle device 2 for the fuel cartridge 1 drawn in FIG. 1(i).

The receptacle device 2 exhibits retaining devices 2c which provide safe and stable positioning of a fuel cartridge 1 inserted into the receptacle device 2. Simple, but nevertheless reliable versions of such retaining devices 2c comprise, for example, spring-loaded retention hooks and spiral springs.

Furthermore, the receptacle device 2 exhibits a connecting device 2b which provides a connection, sealed against fluids with respect to the surroundings, especially in relation to the fuel used, between the outlet 1a of the cartridge 1 and a fuel extraction device 2a (for example a pipe) leading away from the receptacle device 2. The connecting device 2b can comprise, for example, a coupling device with a flange (including seals) matched to the outlet section of the cartridge. In especially preferred embodiments this connecting device 2b is also used for opening the fuel cartridge. A simple example of this is a hollow needle which penetrates the outlet section 1a of the cartridge 1 when being pushed in or when latching the cartridge 1 into the receptacle device 2 and hence providing a fluid connection between the fuel reservoir in the cartridge 1 and the fuel line 2a leading away from the receptacle device 2.

Preferably, both the cartridge receptacle device 2 and the fuel cartridge 1 exhibit mutually matching guidance devices and centring devices (not illustrated) which are used for insertion and the precise positioning of the fuel cartridge 1 in the receptacle device 2. If the cartridge exhibits a safety device, which should be damaged during the insertion stage into the cartridge receptacle device and/or during the removal stage from the cartridge receptacle device, then—depending on the formation of this safety device—special devices can be provided for this purpose in the cartridge receptacle device 2 to realise this damage. Alternatively, this damage can also be achieved by means of the guidance devices and centring devices mentioned above or by standard devices such as the opening device 2b.

FIG. 1(iii) shows the cartridge receptacle device 2 of FIG. 1(ii) together with an inserted fuel cartridge 1 from FIG. 1(i). In the state illustrated in FIG. 1(iii) fuel can be extracted from the fuel cartridge 1 via the fuel line 2a.

Precise dosing of the fuel flow fed is required for controlled operation of a fuel cell system.

Starting from FIG. 1(iii) this type of dosing can occur as illustrated in FIG. 2(iii):

According to FIG. 2(iii), the fuel extracted from a fuel cartridge via the fuel line 2a passes through a dosing device 3 which controls the fuel flow fed to the fuel cell system.

Alternative methods of arrangement of a dosing device 3 are drawn in FIGS. 2(i) and 2(ii):

FIG. 2(i) shows a fuel cartridge 1 with integrated dosing device 3. In this respect there are the following possibilities: a) the dosing device 3 is provided completely within the housing of the fuel cartridge 1, that is before the actual outlet 1a (left partial picture); b) the dosing device 3 is integrated into the outlet device 1a of the fuel cartridge 1 or is located directly on the outlet device 1a of the fuel cartridge 1 (right partial picture). The receptacle device must, of course, be appropriately adapted for these versions.

With the following figures reference symbols which are the same or increased in each case by 100 are used for features with the same or equivalent correspondence. A detailed treatment of the functional properties of these types of structurally and/or functionally comparative features is omitted if this would only lead to a repetition of facts already comprehensively described in conjunction with previous figures.

FIG. 3 shows a first embodiment of a fuel cartridge 1 according to this invention.

The cartridge 1 exhibits a dimensionally stable outer housing 1b which exhibits a closure device 311 at one end, the said closure device closing an outlet 1a. Within the housing 1b, an inner sleeve 312 is provided which runs parallel to the longitudinal axis of the housing 1b and is joined sealed against fluids (i.e. sealed against gas and/or liquid) with the inner surface of the end at the outlet end and the inner surface of the end of the housing opposite to the outlet end. In this case the inner sleeve 312 is formed as a bellows (for example from an elastomer). The inside of the cartridge 1 is subdivided into a fuel chamber 1c and a second chamber 313, which in this embodiment is filled with a gas subject to a pressure. The fuel chamber 1c is separated from the gas chamber 313 by a partition wall 314 which extends perpendicular to the cartridge longitudinal axis and which is welded to the bellows 312. The bellows 312 similarly prevents mixing of the pressure gas and the fuel.

Since the partition wall 314 is only held by the elastomer, but can move freely along the longitudinal direction of the housing 1b, the fuel in the fuel chamber 1c is consequently also subject to essentially the same pressure as the gas. Hence, opening the closure device 311 to the outlet opening 1a causes fuel to be forced through it from the cartridge 1.

With the illustrated embodiment the gas in the gas chamber 313 exhibits a specified initial pressure which reduces as the cartridge empties. Alternatively, the end of the housing 1b closing the gas chamber can be fitted with a gas connection and a non-return valve to supply gas in parallel to the emptying of the cartridge 1, therefore maintaining the gas pressure in the gas chamber to a constant or variable value.

The type of materials used for the cartridge 1 depends substantially on the chemical properties of the fuel, but also on the fields of application of the fuel cell. An outer housing 1b of metal is mechanically and thermally more stable than a plastic housing. Due to the higher material strength, higher internal pressures can be used. With the same external dimensions a larger internal volume can be obtained. In comparison, plastics have a weight advantage and are more dimensionally stable with regard to moderate external forces.

In particular with methanol as the fuel, it should be noted that most plastics in contrast to metals exhibit a permeability for methanol which cannot be neglected and is sometimes quite high.

When using methanol as the fuel, the outer housings 1b of the described fuel cartridges 1 are therefore produced with preference for the use of metallic materials. Housings completely made of metal as well as the use of composite materials containing metal and/or metal-coated materials can be considered.

FIG. 4 shows another embodiment of a fuel cartridge according to the invention. The parts corresponding to FIG. 3 are only described in the following where differences occur to the embodiment shown in FIG. 3.

The cartridge 1 exhibits at the outlet end a fuel chamber 1c which is isolated from the rest of the housing interior by a bellows 412 and a partition wall 414, whereby the latter is permanently joined to the free end of the bellows 412. The end of the bellows 412 at the outlet end is, as with the embodiment of FIG. 3, permanently joined to the internal wall of the housing 1b. In contrast to FIG. 3, the bellows 412 here does not extend along the complete longitudinal direction of the housing 451 and is only fixed at the outlet end to the internal side of the housing 1b.

Whereas with the embodiment in FIG. 3 a gas subject to pressure supplies the energy required to displace the fuel, in this respect with the embodiment in FIG. 4 a spiral spring 415 is used which is provided in the pretensioned state between one end of the housing and the partition wall 414.

The outlet opening 1a is closed by a non-return valve 411 which can be opened by an external device which can be inserted along the outlet opening. In order to achieve the highest possible degree of emptying, the partition wall 414 exhibits a central piston-shaped bulge which extends into the spiral spring 415 and through which the partition wall 414 is prevented from coming into contact with the non-return valve 411.

Another embodiment of a fuel cartridge according to the invention is drawn in FIG. 5:

The fuel cartridge 1 of FIG. 5 exhibits a double jacket similar to that in FIG. 3. The outer jacket is formed by the outer housing 1b and lends mechanical stability to the cartridge, whereas the inner jacket 512 defines the actual fuel chamber 1c.

The inner jacket 512 is in turn permanently joined to the internal side of the housing 1b at the outlet end and on the opposite end of the housing can freely move along the housing axis. The fuel chamber 1c can be emptied in the direction of the outlet 1a by opening the closure device 511. The inner jacket 512 is formed elastically such that it tends to draw together or fold in. This property of the inner jacket is achieved in that it is formed either completely from an elastic material or as bellows of a more or less elastic envelope material in conjunction with an element providing elasticity. In this embodiment a spiral spring standing under tension is injected into the bellows. Consequently, a pressure is exerted on the fuel within the fuel chamber 1c which causes the fuel to be displaced through the outlet opening 1a on opening the cartridge 1.

Since on emptying the cartridge 1 the volume of the fuel chamber 1c reduces, the formation of a vacuum between the inner and outer jackets which would prevent the complete emptying must be avoided. In this respect an opening 516 is provided in the wall of the outer envelope 1b, the said opening enabling pressure equalisation with the ambient. In order to ensure that no fuel can be emitted from the opening 516 if damage to the inner jacket 512 occurs, it is expedient to fit a non-return valve (not illustrated) to this opening 516. This is above all then necessary when the fuel has properties injurious to health or is chemically aggressive and can diffuse through the chamber wall of the fuel chamber 515.

The cartridges shown in FIGS. 3 to 5 are in accordance with an active type with which the action required for emptying is provided by devices of the cartridge 1 itself, whereby in the illustrated embodiments the action is achieved by applying pressure.

FIG. 6 shows a “passive” fuel cartridge 1, i.e. a cartridge with which the opening of the closure device 611 does not automatically lead to self-discharge of the cartridge 1. Furthermore, this fuel cartridge 1 represents an embodiment of the type drawn in the left partial picture of FIG. 2(i), in which the main constituent parts of the dosing device 3 are integrated into the fuel cartridge 1.

In the cartridge 1 a peristaltic pump impeller 617 is integrated which is located between the actual fuel chamber 1c and the outlet 1a. Emptying occurs by rotating the pump impeller 617 and it is supported by gravitation acting on the liquid fuel. Therefore, the effective operation position of the cartridge 1 shown in FIG. 6 is vertical with the outlet 1a towards the bottom. Preferably the motor for driving the pump impeller 617 is not a constituent part of the cartridge 1, but is integrated into the cartridge receptacle device 2 for the cartridge 1.

The fuel itself is located inside a bag 612 which extends to the outlet 1c of the cartridge 1. In the peripheral section of the pump impeller 617 the bag 612 narrows to become a tube, whereby the tube diameter can be modified by the movable slide 618.

By rotating the pump impeller 660 in the counter-clockwise direction successive amounts of liquid of a specified volume are forced out of the fuel chamber 1c into the tube section and delivered to the outside at the outlet opening 1a which is fitted with a sealing lip 611.

The dosing of the fuel flow, i.e. the control of the volume flow delivered through the outlet opening 1a, can, for example, occur directly by means of the control of the speed of rotation of the pump impeller 617. In this case the tube diameter could be specified at a predetermined value and the movable slide 618 could be omitted. Alternatively, the pump impeller 617 can in the ideal case be driven at a constant rotational speed, whereby the volume flow is essentially controlled by varying the tube diameter by sliding the slider 618. It is also possible however that the slide of the slider 618 exerts a contact pressure on the pump impeller which is not negligible, causing a reduction in the rotational speed of the pump impeller 617. This must be taken into account in the control of the dosing of the volume flow to be delivered.

The above described embodiment of the cartridge 1 is more complex than the one illustrated in FIGS. 3 to 5. However, it has the advantage that a simple dosing of the volume flow is possible and a separate dosing unit 3 is not required. A further advantage, not immediately apparent due to the fact that the figure is not to scale, is that the by far largest portion of the inner volume can be exploited for the storage of fuel.

Another embodiment of a passive fuel cartridge is drawn in FIG. 7 which also shows an embodiment of the type drawn in FIG. 2(ii) in which the essential constituent parts of the dosing device 3 are integrated into the cartridge receptacle device 2.

The fuel cartridge 1 in FIG. 7 is inserted into a cartridge receptacle device 2. Similar to the cartridge in FIG. 4, this cartridge exhibits a piston surface 714 which can move freely along the longitudinal axis of the cartridge and which, together with a roll diaphragm 712 mounted on the inner end of the outlet of the cartridge housing, defines the fuel chamber 1c. In the fully filled state the piston surface 714 is essentially located on the housing end opposite the outlet. By exerting a force on the piston surface 714 aligned in the direction of the outlet, a pressure required for the extraction of fuel is exerted on the liquid fuel present in the fuel chamber 1c.

In the illustrated embodiment the force on the outer end of the piston is essentially applied by a cup spring assembly 731. A double spindle 732, which is driven by a stepper motor that is not illustrated, is provided between the cup spring assembly 731 and the piston surface 714 for the control of the piston displacement and hence the dosing of the fuel flow from the fuel cell 1.

FIG. 8 shows relevant parts of another embodiment of a fuel cartridge and a corresponding cartridge receptacle device. Only those features of the cartridge receptacle device are drawn which provide the applied pressure of the cartridge.

The cartridge 1 exhibits two movable pistons 814 and 815 which are spaced by a spiral spring 815 permanently joined to the piston. The axis of the spiral spring is essentially aligned to the axis of the housing.

With the free cartridge and also in the illustrated state, the spiral spring 815 is released or only slightly preloaded so that the fuel in the fuel chamber 1c stands under negligible pressure.

The receptacle device for the cartridge 1 exhibits a cam 821 which can be rotated by means of a handle 822 about a point of rotation 823. With the cartridge 1 inserted and when the handle 822 is operated and the cam 821 is rotated, the piston surface 824 is displaced in the direction of the piston surface 814, whereby the spiral spring is compressed and in turn exerts a pressure on the fuel situated in the fuel chamber 1c.

In the following FIGS. 9 to 12 various preferred embodiments are described for the realisation of an interface for extracting the fuel between the fuel cartridge 1 and the fuel extraction devices (cf. FIG. 1).

A basic differentiating feature of the cartridges within the scope of this invention is the type of interface through which the cartridges are emptied:

In this regard the interface at the cartridge end can be implemented such that it is irreversibly damaged during the insertion process, for example by perforation of the housing (similar to the gas cartridges used in the field of camping).

Alternatively, such an interface—as illustrated in FIGS. 9A and 9B—can exhibit a septum 911 which is penetrated by the needle tip 2b during insertion. Due to the elastic properties of the septum, the cartridge closes again when the needle is withdrawn so that the septum represents a quasi reversible closure device.

The interfaces described in conjunction with FIGS. 10 to 12 are in contrast not damaged during the emptying process and are therefore preferred for reusable cartridges. With these types of cartridge it is also more easily possible to interrupt the emptying process and to remove the cartridge from the cartridge receptacle device when it has only been partially emptied.

FIGS. 9A and 9B illustrate a first preferred embodiment of an interface.

FIG. 9A shows the start of the insertion process of the cartridge 1 in the cartridge receptacle device 2.

The outlet section 1a of the cartridge 1 exhibits a septum 911 which is held by a holder permanently joined to the housing 1b. Within the septum 911 a recess for better guidance of a hollow needle 2b penetrating the septum is provided centrally.

In the situation illustrated in FIG. 9B the insertion process has been concluded. Here, the hollow needle 2b has pierced the septum 911 and has penetrated so far into the cartridge 1 that the needle opening reaches into the fuel tank 1c so that fuel extraction through the hollow needle is possible.

The fuel extracted through the needle 2b flows out of the end of the needle 2b remote from the cartridge into the fuel extraction device 2a which for example can comprise filter devices 925 and an intermediate reservoir 926 from where the fuel can be fed to the fuel cell device by means of an intervening dosing unit 3 (cf. FIG. 2).

The cartridge 1 shown in FIG. 9 is distinguished in that the septum 911, which the cartridge closes in the original state, is penetrated by the needle 2b, i.e. it is irreversibly damaged, but it exhibits elastic properties so that the cartridge 1 is closed again when the needle 2b is withdrawn. Consequently, this type of cartridge need not necessarily be completely emptied after being fitted, but, due to these quasi reversible properties of the septum, it can be removed also in the partially emptied state without concerns about safety.

Compared with this, FIGS. 10 and 11 illustrate embodiments of the cartridge 1 which exhibit a completely reversible opening mechanism and which are therefore more flexible than the cartridge of FIG. 9, but at the same time have a somewhat more complex construction.

The fuel cartridge 1 of FIG. 10 exhibits an outlet device 1a at the head of the cartridge with a longitudinal hole extending into the interior of the cartridge. Perpendicular to the longitudinal hole, a side fuel channel 1019 communicating with the fuel chamber is provided. At the level of this channel 1019 a sleeve 1011 under the action of a spring is provided in the longitudinal hole, the said sleeve blocking the side channel 1019. The sleeve 1011 can be moved so far against the spring force in the direction of the opposite end of the housing such that the side channel 1019 is released, so that fuel can flow out of the fuel chamber 1c into the longitudinal channel.

FIG. 10B schematically illustrates the device used for emptying the fuel cartridge. For this, a piston 2b is provided, the shape and size of which are matched to the outlet section 1a of the fuel cartridge 1. Like the needle described in conjunction with the one in FIG. 9, this piston 2b is hollow inside, whereby the hollow needle formed in the piston is used for fuel extraction. On pushing in the piston 2b into the outlet section 1a of the fuel cartridge 1, the end section of the piston comes into contact with the sleeve 1011 and with further insertion, causes the sleeve 1011 to be pushed against the action of the spring.

In the illustrated state the sleeve 1011 is finally inserted so far that the hollow needle of the piston is in fluid communication with the fuel chamber 1c so that fuel extraction can occur.

FIGS. 11A and 11B illustrate a cross section of the outlet section 1a of a fuel cartridge 1 and the corresponding cross section of parts of the fuel extraction devices.

As in the cartridge of FIG. 10 a side outlet channel 1119 is provided in the fuel cartridge 1, which in contrast however is not closed by a movable part (in FIG. 10: sleeve 1011), but rather by a rotatable blocking part 1111. This blocking part 1111 exhibits a hole which can be brought into alignment with the side outlet channel 1119 by rotating the blocking part 1111.

For the rotation of the blocking part 1111 a joining device 2b in the form of a T-shaped key is provided which can be placed into the longitudinal hole of the outlet 1a from outside and which can engage the blocking part. The element of the key 2b corresponding to the crossbar of the “T” exhibits a through channel 1127. The vertical bar of the “T” represents a handle 1122 for turning the key 2b.

Turning the key 2b by operating the handle 1122 causes rotation of the blocking part 1111 and opening of the cartridge when the hole of the blocking part 1111 and the outlet channel are aligned with one another.

On the end of the T-piece facing the fuel line 2a a further blocking part 1128 can be provided for safety and as a return-flow inhibitor, the said blocking part 1128 being simultaneously opened with the blocking part 1111 by turning the key 2b.

FIGS. 12 and 13 show two preferred embodiments of dosing devices 3 according to the principles of FIGS. 2(ii, iii) which immediately follow the joining device 2b causing the opening of the fuel cartridge. These dosing devices 3 exhibit a valve 3a which can be operated by means of a magnetic coil 1233 (FIG. 12) or a piezoelement 1333 (FIG. 13). In these examples the valve 3a is formed as a disc valve.

Instead of the disc valve, alternatively needle valves, diaphragm valves, slide valves, etc. can be used. Furthermore, the dosing device can also comprise pump devices, in particular micropumps.

FIGS. 14A, 14B and 15 schematically illustrate a subdivision of a housing G, advantageously matched, which is set up for the accommodation of devices of this invention, which serve the fuel supply of a fuel cell, together with the fuel cell itself.

Here, FIGS. 14A and 15B illustrate the rear and front elevations of the empty housing G which is subdivided into three in the preferred embodiment, whereby compartments for all the devices required for operating a fuel cell device—including the fuel cell device itself—can be accommodated within the housing. The reference symbol GB refers to the compartment for receiving the fuel cell device, GD to the compartment for receiving a dosing device and 2 is the compartment for receiving a fuel cartridge. For the sake of simplicity, no equipment such as fuel lines, etc. are shown.

In FIG. 14A a cylindrical recess 2A is shown with a hole through the rear wall of the fuel cartridge compartment 2, whereby the hole is arranged such that it corresponds with the outlet of an inserted fuel cartridge according to the invention. This recess can for example also act as an intermediate reservoir between the fuel cartridge and the dosing unit. As will be realised, the three-way subdivision is only an example and no inventive activity is needed to apply other subdivisions in place of the one shown.

As the front elevation of the housing G in FIG. 14B illustrates, the cartridge compartment 2 can exhibit various elements which serve the insertion, exact guidance and holding of the fuel cartridge:

guidance ribs R, which match corresponding indentations in the cartridge outer wall, ensure precise guidance of the cartridge and minimise sideward deviations (play perpendicular to the cartridge longitudinal axis);

spiral springs (which are drawn in FIG. 2 and in the following FIG. 15) retained by the spring guides FF ensure that, in combination with a latching hook H, an inserted cartridge is held without play along the cartridge longitudinal axis.

Finally, FIG. 15 shows a skeleton view of the housing drawn in the FIG. 14 with an inserted fuel cartridge 1.

The two springs 2c can be provided—depending on practicability—on the outer surface at the outlet end of the fuel cartridge 1 or—preferably—on the spring guides FF drawn in FIG. 14B.

With the embodiment described above no separate fuel tank was provided. In these cases the fuel cartridge acts directly as the tank cartridge which is gradually emptied as the fuel cell is operated.

Alternatively, the fuel cartridge can act as a refill cartridge which is essentially emptied all at once to fill a separate fuel tank. Since in this case no fine dosing of the fuel flow is required for emptying the cartridge, fuel cartridges for this type of application can normally be constructed more simply than the tank cartridges described above. A further advantage of this type of embodiment is that the fuel cell device can be operated without interruption, because replacement of the fuel cartridge is not linked to an interruption in the fuel supply.

In the case of an application as a tank cartridge, operation of the fuel cell device is possible without interruption when an intermediate reservoir is provided which contains an adequate reserve of fuel to continue to operate the fuel cell device for the period required to replace the tank cartridge. This intermediate reservoir is preferably integrated into the receptacle device for the fuel cartridge. Alternatively, uninterrupted operation of the fuel cell device also without this type of intermediate reservoir is possible if the fuel cell device is formed such that at least two fuel cartridges can be connected in parallel.

1. Fuel cartridge for the supply of a fuel cell device, with an outlet device, which is formed such that it can be opened by an opening device of a cartridge receptacle device appropriate to the fuel cartridge.

2. Fuel cartridge according to claim 1, with a device to apply pressure to the fuel in a fuel chamber of the fuel cartridge.

3. Fuel cartridge according to claim 2, in which the device applying the pressure comprises a gas.

4. Fuel cartridge according to claim 2, in which the device for applying the pressure comprises a compression spring.

5. Fuel cartridge according to one of the claims 2 to 4 claim 2, in which the device for applying the pressure comprises devices in order to apply pressure to the fuel in the fuel cartridge by the application of an external force.

6. Fuel cartridge according to claim 1, with a closure device closing off the outlet device of the cartridge, the said closure device enabling a reversible opening and closure of the fuel cartridge.

7. Fuel cartridge according to claim 1, with a filling level indicator to indicate the level of fuel in the cartridge.

8. Fuel cartridge according to claim 1, with a dosing device to control a fuel flow from the cartridge.

9. Fuel cartridge according to claim 8, whereby the dosing device comprises a pump device.

10. Fuel cartridge according to claim 9, whereby the pump device comprises a micropump.

11. Fuel cartridge according to claim 8, whereby the dosing device comprises at least one valve which can be actuated.

12. Fuel cartridge according to claim 11, whereby the at least one valve can be actuated magnetically or piezoelectrically.

13. Fuel cartridge according to claim 11, whereby the at least one valve comprises a needle valve and/or a disc valve and/or a slide valve.

14. Fuel cartridge according to claim 1, for application as a refill cartridge for filling a fuel tank of the fuel cell device.

15. Fuel cartridge according to claim 1, for application as a tank cartridge.

16. Fuel cartridge according to claim 1 with a safety device, which is damaged during a process of insertion into the cartridge receptacle device and/or a process of removal from the cartridge receptacle device.

17. Cartridge receptacle device for a fuel cartridge according claim 1, comprising:
guidance and retention devices for guiding and retaining the fuel cartridge; opening devices for opening the fuel cartridge; and
fuel extraction devices for extracting the fuel from the fuel cartridge.

18. Cartridge receptacle device according to claim 17, with a device for applying a pressure to the fuel in a fuel chamber of the fuel cartridge.

19. Cartridge receptacle device according to claim 18, in which the device for applying the pressure comprises a gas.

20. Cartridge receptacle device according to claim 18, in which the device for applying the pressure comprises a compression spring.

21. Cartridge receptacle device according to claim 17, in which the fuel extraction devices comprise a dosing device.

22. Cartridge receptacle device according to claim 21, whereby the dosing device comprises a pump device.

23. Cartridge receptacle device according to claim 22, whereby the pump device comprises a micropump.

24. Cartridge receptacle device according to claim 21, whereby the dosing device comprises at least one valve which can be actuated.

25. Cartridge receptacle device according to claim 24, whereby the at least one valve can be actuated magnetically or piezoelectrically.

26. Cartridge receptacle device according to claim 25, whereby the at least one valve comprises a needle valve and/or a disc valve and/or a slide valve.

27. Cartridge receptacle device according to claim 17, in which the guidance and retention devices comprise at least one latching element and/or at least one compression spring and/or at least one guide rail and/or at least one centring element.

28. Fuel cell device with at least one cartridge receptacle device according to claim 17.
